(19) United States
(12) Patent Application Publication
(10) Pub. No.: US 2020/0090227 A1
(43) Pub. Date: Mar. 19, 2020

(54) Method and system for electronic crowd communication

(71) Applicants: Elliot Furman, New York, NY (US); Weston Parker Headley, Seattle, WA (US)

(72) Inventors: Elliot Furman, New York, NY (US); Weston Parker Headley, Seattle, WA (US)

(21) Appl. No.: 16/574,366

(22) Filed: Sep. 18, 2019

Related U.S. Application Data
(60) Provisional application No. 62/732,944, filed on Sep. 18, 2018.

(51) Int. Cl. G06Q 30/02

(52) U.S. Cl. CPC G06Q 30/0267; G06Q 30/0257

(57) ABSTRACT

An application on a mobile phone in communication with various systems such as databases which include data on consumers and targets, and also in communication with an automated load balancing calling system, enables a multiplicity of consumers to talk to targets about various issues that are important to them. These issues, which are part of a campaign, may comprise any subject such as political, corporate citizenship, environmental, social justice, financial, or any other issue that can be thought of and/or that someone would like to voice their opinion on.

This application claims the benefit of U.S. Provisional Application No. 62/732,944, filed Sep. 18, 2018, which are hereby incorporated by reference.

### BACKGROUND

A need presently exists for a method and system for electronic crowd communication

### SUMMARY

In a method for electronic crowd communication for consumers to contact targets according to a campaign, at least one campaign is created comprising at least one issue stored in a campaign database, wherein the campaign is created by a campaign manager application. A target database is created wherein the target database comprises a plurality of targets wherein each target is linked to at least one of the campaign of (a), wherein the target database comprises contact information of each target. A consumer profile is created comprising name, date of birth, voting district information, contact information, and time calling preferences the consumer is available for calls. A campaign database is created with an online campaign manager application. A consumer app executes on a mobile device of a user. A campaign is transmitted from the campaign manager to the consumer app of users having a consumer profile that matches the requirements of the campaign. Input is received from users by way of their consumer app indicating the user would like to support the campaign. Then, according to the time calling preferences, automatedly calling the target and connecting the consumer to the target so that the consumer can speak with the target, wherein automatedly calling further comprises queuing calls and load balancing calls to the targets according to the number of consumers available to call the target based on the consumer's time calling preferences.

### BRIEF DESCRIPTION OF THE DRAWINGS

FIG. 1 shows the components of an electronic crowd communication system.

FIG. 2 shows a process for an electronic crowd communication system.

### DETAILED DESCRIPTION

The following terms are defined herein as follows:

A “Target” is a politician, government agency, business, other policy making organization;

A “Consumer” is an end consumer who wants to call a Target organization;

A “Consumer Profile” includes name, address, and a zip code as a proxy of a location in terms of voting registration;

“Consumer Preferences” include demographics and when a consumer prefers to make calls and what types of issues matter to them;

A “Consumer App” is software aimed at serving the Consumer;

“Communications” include all calls to Targets, and Repurposed Content;

“Repurposed Content” means turning calls into voice diaries such as notes or transcribed letters, emails, or faxes;

“Social Sharing” means sharing content on social networks such as Twitter and Facebook so Consumer or Campaign Organizer can share Communications with others;

A “Campaign” is a promotional campaign to get Consumers to call Target(s) about an issue and to do so within a defined timeframe;

A “Campaigner” is an activist professional that would like to persuade Consumers to call Targets;

A “Campaign Organization App” is software for Campaigner to launch Campaigns to activate Consumers;

“Campaign Management” refers to a Campaigner's ability to schedule, monitor, and refine Campaigns;

“Guideline Collateral” includes text, audio, video provided by Campaigner to motivate or guide Consumers;

“Campaign Invitations” include parameters on the type of Consumers that Campaigner wants to participate;

A “Target Database” includes the phone numbers and issues associated with each Target;

A “Communications QC Engine” includes methods to screen-out or filter communications involving hate, lies, fraud and other communications that are deemed offensive or detrimental;

“Bilateral Calls” are “live” calls between Consumers and Targets that require a Target to agree to a recording;

“Unilateral Calls” are “live” or “diary” calls where Consumers can unilaterally agree to a recording;

“Load Balancing” means allocating phone lines and the availability of phone lines to a particular Target based on number of Consumers ready to call a given Target, the number of different Campaigns directed at the same Target, past performance of calls actually completed by relevant Consumers and Campaigners, and an optional premium status of a Campaigner, Campaign Organization, or Consumer, including those who pay a premium;

“Media Outlets” include journalists, academics, redistricting commissions and others who may be interested either in the Communications to a Target and the Analytics/Reports on the number of Consumers, Campaigners and Communications with a particular Target or related to multiple Targets on a particular issue or topic.

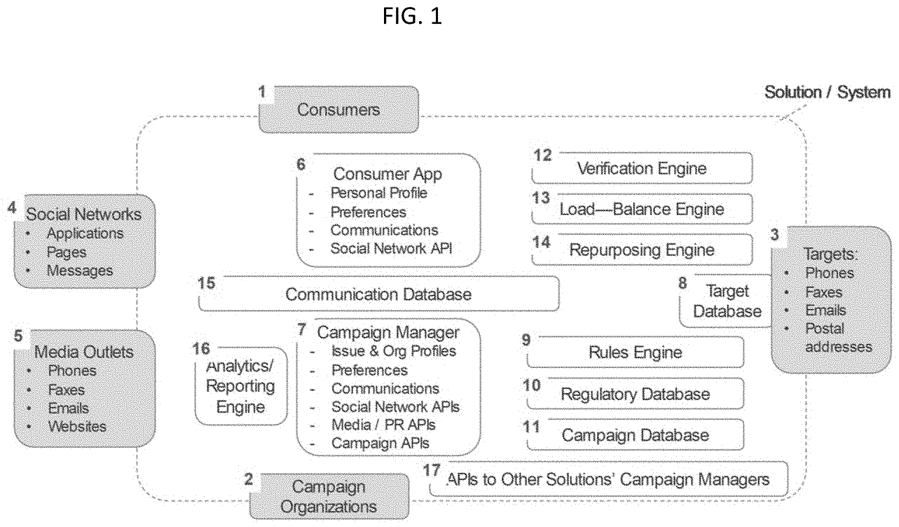

FIG. 1 shows the components of an electronic crowd communication system. With reference to FIG. 1,

Consumers 1 are desirous of having their voices heard either as voters, consumers, or policy-making influencers;

Organizations 2 such as non-profits, political parties, or businesses want to mobilize Consumers for their cause/issue/policy;

Targets 3, that is target organizations include politicians, policy makers, businesses who Consumers and other Organizations want to influence;

Social Networks 4 include FaceBook, Twitter, and the like and are used by Consumers, Organizations, Targets, Media Outlets;

Media Outlets 5 include companies and journalists and others who do not participate directly in activism but report on it;

A Consumer App 6 is a mobile, PC, and/or web application used by Consumers to create and enter their Profile and Preferences, accept Campaign Invites, perform Calls to Targets, do any Repurposing of their outbound Calls, share their Call or Repurposed Content via “Co-Patriot” friends within the App's in-app social network or share via APIs to third-party Social Networks;

Campaign Manager 7 is an application used by Organizational users who want to recruit Consumers to support the organization's effort to organize a Campaign of people calling a specified Target;

Target Database 8 is a Database of all Targets including their phone numbers, fax numbers, email addresses, postal address, including. Some Targets may have multiple offices or points of contact;

Rules Engine 9 draws upon the Campaign's parameters, Consumer Profile and Preferences, the Solution owner's internal administrative rules (e.g. restricting hate speech or spam) and government regulations to help establish that a Campaign meets the requirements, and which Consumers can and should be invited to the particular Campaign;

Regulatory Database 10 is a database of government regulations, such as laws about recording calls;

Campaign Database 11 includes all prior Campaigns, the invited Consumers and the guidance Collateral that the Campaign provides to Consumers either to get them to a) accept the invitation and register with the Campaign, which might have timeframes that people sign-up to make a call on (e.g. “I'll call tonight vs. tomorrow”); b) motivate them to follow up on their registration; c) reminders; and d) fact sheets or talking points that the Consumers can use when they communicate to the Target;

Verification Engine 12 compares a Consumer Profile, an in particular location and age, to ensure that they meet the Campaign's objectives relative to the Target(s). For example, if the Campaign is to contact a State Senator, the Verification engine ensures that only Consumers who are registered to vote or at least located in the State Senator's district are invited to the Campaign;

Load-Balancing Engine 13 allocate Consumer calls to Targets, and alerts requesting that a Consumer call, based on all the Consumers who have registered for a given Campaign that is targeting a particular Target, all the other Campaigns trying to also influence the same Target, and including directing Consumer calls to alternative phone numbers for a particular Target if available;

Repurposing Engine 14 allows a Caller who just made a call to a Target to repurpose that dialogue into additional formats, including recording the call made to the Target (depending on local telecommunication laws), making a separate “voice diary” recording of what someone just said to or heard from the Target, doing an automatic transcription of either recording into text, allowing the Consumer to spell check the text, taking said text and having it sent as a fax, email or postal letter to the Target;

Communication Database 15 stored all the recorded calls, recorded audio diaries, emails, faxes, letters, sharing links to 3^{rd} party social networks, social sharing notes and links to the solutions internal “in-app” social network;

Analytics/Reporting Engine 16 provide reports to Consumers, Campaign Organizations, Targets, Media Outlets, and allows Campaign Organizations, Targets and Media Outlets to create and execute custom analyses; and

Application Programing Interfaces (APIs) 17 provide a standardized set of commands and procedures to interface with third-party Social Networks to enable sharing to FaceBook, Twitter, etc.

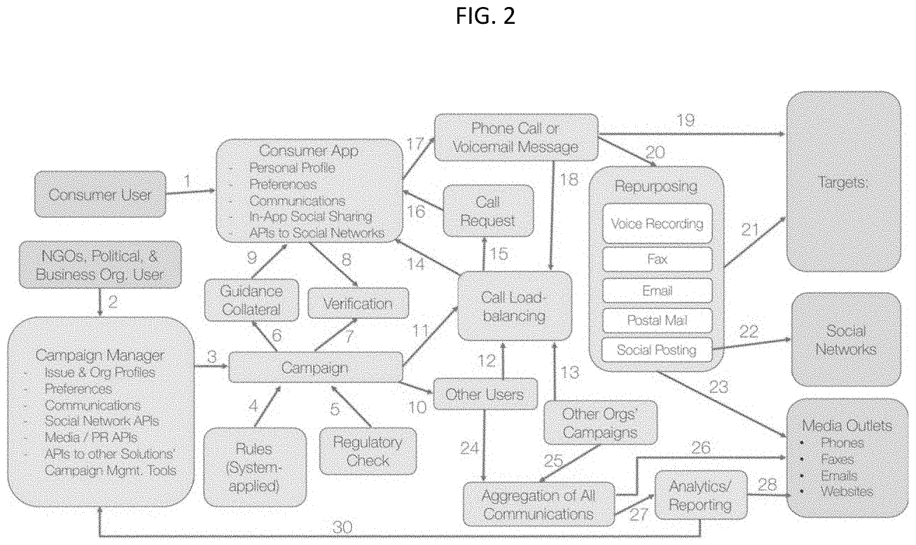

FIG. 2 shows a process for an electronic crowd communication system. With reference to FIG. 2 and labeled process arrows,

1. Consumer downloads app on phone or computer, where they create a) a Profile of their personal information including zip code and voter registration information, b) their Preferences with regard to which issues (e.g. political, economic, social, consumer) they care about enough to make phone calls to influence Targets (politicians, businesses, NGOs, etc.); c) their Preferences regarding when and how they want to make phone calls (e.g. evenings via home computer, mornings via mobile) and how they want to be alerted to Call Requests (e.g. 1 minute versus 1 hour before); d) their Preferences regarding default communications (e.g. whether they agree to have all calls repurposed, recorded, shared); e) their Social Network credentials and preferences (e.g. so they can say they do or don't want their latest calls or repurposed communications posted on their FaceBook page or posted on Twitter);

2. An employee/staff member of an organization downloads or SaaS-subscribes to a Campaign Manager account that is software enabled, so that they set-up the account by a) identifying the issues that the Organization focuses upon; b) fills out an Organization Profile explaining their status so that Consumer Users can understand the sponsor of the Campaigns; c) establishing default preferences for what type of Campaigns and repurposing is used; d) establishing whether/how the Campaigns' and resulting User Communications will be published on the Org's social media or website; e) identifying which journalists or media organizations should have access to or be alerted to new Campaigns, Communications and Analytics relating thereto; f) connecting this Solutions' Campaign Manager to the related Campaign Management Tools of other solutions in this Invention disclosure);

3. Org User designs a Campaign related to a given Issue and targeting certain Targets, with such Campaign design including a) identifying the relevant Issues; b) selecting the relevant Targets from the Target Database; c) establishing the timing parameters of the Campaign (e.g. maximum # of calls in 24 hours or a sustained consistent trickle of influence over 3 months); d) writing the recruitment copy to convince Consumer Users to participate in the Campaign; e) establishing the targeted marketing parameters the recruitment copy to all Consumer Users who've indicated interest in same versus similar Issues and have Profiles that are relevant to the Target (e.g. people in the district of a senator, or people who live near a company);

4. System applies Rules to the Campaign that are based on the System's own internal policies (e.g. to prevent hate speech or avoid certain Issues, or prevent “spamming” of Campaigns);

5. System applies Rules to the Campaign that are based on legal/regulatory issues (e.g. related to national or local telecommunications laws);

6. Org User can review established or draft new Guidance Collateral that provides the Consumer User, where such Collateral can be a combination of a) “cheat sheets” on the messaging that Consumer Users can use when communicating with Targets; or b) “fact sheets” of relevant facts that can inspire Consumer Users to make Calls or send emails, as well as prepare for the communication with Targets;

7. Campaign informs the Verification Engine of the geographies or demographic information in the Consumer User profiles that is required for each of the Targets identified in the Campaign; the Verification Engine uses this Campaign-submitted information and cross-checks with the Regulatory Check and Target databases to confirm which people can be System-Verified as appropriate participants;

8. Verification Engine draws upon database of Consumer Profiles to ascertain which Users should be recipients of the Campaign broadcast;

9. Once the appropriate Consumer Users are identified and verified, then the Campaign and associated Guidance Collateral are broadcast to the Consumer User (assuming their Profile matches) and said User either registers as a participant in the Campaign, or saves as a favorite to consider for future participation (with such User participation/interest data sent to the Campaign Mgmt app);

10. Campaign is also broadcast to many other Consumer Uses with appropriately matching Profiles;

11. Campaign is registered with the Load-Balancing Engine, which analyses the likelihood based on past performance of the Org User and the Consumer User of the Consumer User actually making calls and when (based on their Personal Profiles);

12. Load-Balancing Engine analyses the total # of Consumer Users invited to the Campaign; the likelihood based on past performance of the Org User and the Consumer Users of the Consumer Users actually making calls and when (based on their Personal Profiles);

13. Load-Balancing Engine analyses the likely load of other Campaigns' of other Organizational Users (whether other employees of the same Organization or different Organizations;

14. Load-Balancing Engine gives real-time updates to the Consumer User of when they're most likely be able to reach the Target(s) in the Campaign they've registered to participate in or have flagged as a favorite to possibly participate in;

15. Load-Balancing Engine will periodically (depending on caller activity, load-balance algorithms and Target's capability to accept phone calls) trigger a Call Request to all participating Consumer Users;

16. Call Request is sent to the Consumer User if/when the Consumer User has not “muted” the application (either manually by pushing a “mute” button on the app or automatically by the app detecting the user is on a phone call, running, in a poor cell reception area);

17. Consumer User decides whether or not to respond to the Call Request by initiating a call (with option to call back later or leave a voicemail message that is saved for later delivery to the Target);

18. Information regarding the success, duration, likely end-time and verified end-time of the Consumer User's call is sent to the Load-Balancing Engine, with likely or verified end-time information being based on either a manual button (“I will finish my call in 30 sec” . . . with countdown once button pushed, or extended if reset button pushed) and/or through historical data on the Users' typical call duration;

19. Phone call/recorded voicemail is delivered to the Target (preferably a live call so that there is dialogue), with the call being recorded if the local telecommunication law allows it (with or without an automated notification of the call being recorded);

20. Repurposing Engine leverages the Consumer Users' recent interaction in one or more ways, including a) having Consumer User do a new voicemail recording to recount their interaction (e.g. “I just called Senator X and said Y”) on precondition of the User giving the System ownership rights to the recording; b) doing an automated text transcription which the Consumer User might correct/edit before it is submitted to the Target via Fax, Email and/or letter sent to Postal Mail; c) editing down the voice recording or the text down to a size that is appropriate for various Social Media platforms;

21. Delivering the repurposed content to the Target(s) via Fax, Email and/or letter sent to Postal Mail through the System's or by the Consumer User's fax #, email, printer/mail-room;

22. Allowing the edited-down content be posted on third-party Social Media accounts of the Consumer User, the Campaign Organization, or the System. The Consumer App would also enable “in-app” social posting whereby Consumers can review other Consumers' Call s/Repurposed-Content and establish “Co-Patriot” social friendships with other Consumers with similar interests and/or in same Campaigns;

23. Broadcasting the repurposed content (or original phone call or voicemail message, if allowed by law and permitted by the applicable participants of the call) to media outlets;

24. All of the above is done for other Consumer Users' who have registered to and participated in the Campaign;

25. All of the above is done for the Consumer Users' who have registered to and participated in other Campaigns of other Organization users or other Organizations;

26. Aggregating all the Consumer User communications (call, voicemail or repurposed content) into a database;

27. An Analytics and Reporting Engine that identifies trends re. Issues, Targets, Consumer Users, etc.;

28. Analytics and Reporting Engine and its reports are accessed by Media Outlets, Campaign Managers (via 30), Consumers, Targets, and others;

With reference to the above defined terms and FIGS. 1 and 2, an application on a mobile phone such as an iPhone or Android, enables users (also referred to herein as “consumers”) to talk to targets about various issues that are important to them. These issues, which are part of a campaign, may comprise any subject such as political, corporate citizenship, environmental, social justice, financial, or any other issue that can be thought of and/or that someone would like voice their opinion on. In one example, consumers might want to speak up on the their opposition to or support for a nomination for a Supreme Court Justice. In another example, consumers might want to speak up on the nomination of someone to a powerful political post. In another example, consumers might want to be heard on an effort for the government to enact or change laws or policy that they believe could have a detrimental effect on the environment. In another example, consumers may want a corporation to change its policies regarding use of technologies that are perceived as having negative societal impact.

A target is a politician, government agency, business, educational institution, or other organization whose policy-/decision-making activities may be of interest to a sub-set of the broader population. These targets may, for example, wield some influence or have decision power over the issues of interest to the consumer. Various examples of targets include The White House, Senators, Representatives, companies, CEOs, and the like. So, in one example, a senator might have influence over the nomination of the head of the Environmental Protection Agency (EPA). A plurality of consumers, that is citizens, may want to contact that Senator to voice their disapproval in order to try to influence that Senator to withdraw support for the EPA nomination.

Historically, consumers do not know how to contact or even identify the appropriate individual targets, leaving them with political votes or consumer purchase decisions as the only means to express their voices. Such difficulties has led to efforts by non-profit, volunteer or other organizations (also referred to herein as “campaigners”) to help coordinate like-minded consumers and provide them guidance on who the target political representatives or business decision-makers are and how to contact them. For example, some such coordination organizations will establish a website or mobile app that enables like-minded consumers to send an email, even though emails have less impact given the ease to which they can be ignored. For another example, other coordination organizations will have an email campaign sent to like-minded consumers that provides a list of appropriate phone numbers, which has the unfortunate impact of many of the like-minded consumers phoning at the same time and getting busy messages until they either make a call that is luckily at the right time or give up on making more calls due to frustration.

This methods and systems herein, disclose, among other things, ways for those consumers to automatically and easily contact that Senator. And, furthermore, for activists, also referred to herein as a campaigner, to create campaigns of these issues. These campaigns are get consumers to call the targets within a given timeframe. The consumer does not need to research which targets to call. Furthermore, the consumer does have to call multiple times, navigate phone trees, be put on hold, disconnected, in order to reach the proper target. The methods and systems disclosed herein automate all of this.

A campaign is a communication coordination plan that will include an issue (e.g. tax reform), the targets (defined below, with an example being Congressional representatives and senators) of the communication campaign, the timeframe during which consumers will be asked to make calls to the targets (e.g. next week), recruitment copy to help encourage consumers to participate in the campaign and make calls to the targets, suggested talking points for consumers to use as a cheat-sheet to potentially use when making calls, and any other calls to action for consumers (e.g. to share the campaign on social media or via SMS or email to friends, or to contribute financially to support the campaign and the public relations efforts surrounding the campaign, or to support the campaigner's organization).

A target database comprises a plurality of targets. The targets are dependent on the particular issues of the campaign and there may be one or several targets associated with a campaign. But generally, by way of example, the targets comprise, politicians, government agencies, businesses, educational institutions, or other organizations whose policy-/decision-making activities may be of interest to a sub-set of the broader population. The target database comprises phone and fax numbers as well as the policy-/decision-making issues associated with each target. In alternative embodiments, the target database may further or optionally include mailing addresses, email addresses, electronic chat IDs, social networking accounts, and the like for contacting the target by way of other communication means in addition to or instead of telephonic voice communications.

A consumer profile, which may be stored at a server, identifies each consumer who uses the app. While the app presently discussed is an app on a smartphone, it is understood by those having ordinary skill in the art that the app may equivalently be an app operable to function in a web browser or as a social networking app such as Facebook. The consumer profile comprises information about the consumer such as name, date of birth (as proxy for being voting age or not, as many campaigns will likely differentiate whether consumers who want to be campaign participants need to be of voting age or not), zip code (as a proxy for voting district), and contact information such as an email address, phone number, social networking accounts. The consumer profile may further comprise demographic or sociological data about the consumer such location, age, sex, political affiliations, interest in certain issues (e.g. children's education or environment), financial banking or credit card information (e.g. in order to pay for faxes or postal mailings or to donate to the campaign or campaigner's organization), and the like. The profile will also include the consumer's preferred timeframes for which they can make phone calls during or after business hours (e.g. any morning from 8-9 am or after 4 pm, or before noon on Wednesdays). The profile may further include analytics that help paint a picture of the likes and dislikes of the consumer by way of Facebook and other social networking sites.

A campaign database comprises a plurality of campaigns. A campaign manager, that is a web or app frontend, allows a campaigner to create a campaign. The campaign manager includes a website and tool to recruit callers by website, email and/or social media campaign and encourage consumers to schedule calls for maximum impact. A campaign comprises at least one issue.

A consumer app on a user's phone (or computer software application that has phone-call-making capability) is displayed or pushed to the user. This app is a channel for campaigner using the campaign manager software to publish to many consumers the campaigner's campaign issues and campaign logistics of targets and timeframe for making calls. The app and campaign manager software ensures that a campaigner sends their campaign information to only those consumers who are likely to find the campaign of interest according to the consumer's profile and history of campaigns that they have previously supported through participation and possibly also by contributing funds to finance the campaign and/or the campaigner's organization. The consumer app further allows the user to search for issues that may be important to a given consumer or sub-set of the population of consumers who have downloaded the app. Consumers may share campaigns on various social media, encouraging friends to download the app and participate in or financially support one particular campaign or potentially participate in a number of current or future campaigns that support a given issue that the consumer cares about.

When a consumer decides that they would like to speak up on an issue by participating in a given campaign they merely need to press a button displayed by the app, such as “Support the Call!”. They are then registered for the Campaign and their profile's preferred call time information will be used in the sequencing/queuing of phone calls during the campaign's timeframe. Upon doing so, a request is received from the consumer by way of the consumer app that they should be considered to be a participant who will call at least one target associated with the issue of the campaign during the campaign timeframe.

A call server comprises a communication software such as Asterisk. The call server further comprises load balancing software, also referred to as a call scheduler, to coordinate calls according to multiple variables, such as consumer phone-call timing preferences, target's multiple phone numbers and fax machines, target availability, and the like. The load balancing allocates phone lines and availability to a given target according to the number of consumers available to call the target based on consumers' preferred calling times and history of making calls to similar targets or for supporting similar-issue campaigns, the number of different campaigns directed to the same target, historical metrics such as the number of calls actually completed. Also, campaigners may have a “premium status”, which may be a fee a campaigner or campaign pays to elevate their campaign and place a higher priority on their calls over other campaigners (who all have similar accounts with the campaign manager software). Similarly, consumers may pay a premium fee to ensure that they get to have their voices heard sooner rather than later or with more than one target.

Upon receiving the request, a call is queued to be placed to the phone number of associate target. The call is queued such that the call is made during a time when the consumer's profile indicates that the consumer is available to participate in the call. The app may also be connected to the mobile device's phone-dialing software so as to know when another consumer is currently speaking with a target and such other consumer is likely to hang-up soon and make the target's phone-line available for a call, with such likelihood based on either a) statistical or historical analysis and predictive algorithms of such currently-on-the-phone consumer's calls or b) because such currently-on-the-phone consumer has pressed a button on the app that says, “Hanging up in 10 seconds” (which may then initiate a count-down timer that helps remind the caller to hang-up at the appointed time) or c) immediate phone-call bridging functionality, described below.

Calls are queued according to various methods. In one method as will be described below, the caller's zip code is matched with the relevant zip code or codes of the target, for example to make sure that the Caller's zip code in the Congressperson's district. One example of the aforementioned call schedule follows.

For a particular campaign, people receive invitations to the campaign (campaign_invite) via a link, the app, or other means such as disclosed herein. At the call server, occasionally, for example every few seconds the status of the campaign invites are checked. Each time they are checked is called a tick. On each tick, the campaign invite status is checked, for example, whether it is accepted or rejected or still open. Also, the availability the recipient is checked. If the invite is accepted by a consumer, and the consumer's profile indicates that they are available, a call is created.

For example, consumer Joe has slot 10:00-11:00 selected in his profile. The current time of the campaign is 10:20. During this time, though Joe has indicated that he is available for a call, upon the tick the server registers that he has not made a call. The server creates a new CALL entity for Joe's campaigns_invite. Joe then receives notification via for example the app, and the call is made as described herein. When the call is made, is may be successful or fail. If it is a success, the call went through. Joe marks the call as successful. He may provide additional feedback as described below. If it is a failure, the call did not go through and Joe marks the call as Failed. He may also provide additional feedback via the app comprising information regarding why he thinks failed. Some of the feedback may be automatically generated.

In either case, whether successful or failed, after the call or call attempt, Joe is registered as unavailable for another call during the same time slot. And, when Joe's call-entity is created the campaign's number is bound to it and cannot be reused by any other recipient. In other words, the campaign's number is locked for a period of time and cannot be used by anyone else but Joe. Current default for Joe to act on the call notification is 10 minutes, but may be longer or shorter in duration. After this period of time expires, the ticker will unlock the number and will make an attempt to schedule that number with another person, that is with another available consumer.

Zip codes as mentioned above may also be included in the call scheduler. For example, In creating his profile, Joe includes his zip code. Each campaign has a set of targets. Each target contains information about who the person/organization to be called is, their number telephone number or numbers, and their location by zip code.

As in the above example, the ticker continues to check statuses. But additionally the campaigns_invitation creation process filters callers by zip codes so that invitations are to people from the same zip code of the campaign with a specific set of targets.

For example, the following recipients have associated with them the following names and zip codes:

Joe—zip: 11111

Jane—zip: 22222

When a campaign is created for the client (organization) that has target within one of these zipcode, only people who meet any of the zip codes of any of the targets will be available for sending invitation to the campaign. In one example the campaign comprises the following targets:

1) Senator Maphiew—zip: 121212

2) Senator Alan—zip: 22222

In this example, only Jane will be made available available for the invitation and call. Such filtering may be done at the app, at the server, or a combination of both. In this example, Joe will not be able to participate because his zip (11111) does not match any of the targets' zip codes.

The campaign manager, includes an organization portal website. This site allows organizations to register/login and setup their campaigns. The organization portal includes the following functionality:
register/login
verify the account
upload the list of recipients (or allow them to add them manually)
see the list of campaigns they currently have
create a new campaign (with selecting/browsing targets from our DB)

The campaign manager/portal may further include:
analytics information about status of the campaign
adding additional or arbitrary targets

Various other methods for queuing calls are possible. As describe, from the server, the target is called according to queue. The call to the target may not, and may be unlikely, to reach the target on the first try. For example the line may be busy, despite the ability of statistical analyses and the “Hanging-Up in 10 seconds” button to minimize busy signals due to fellow app users' phone calls. Or the call may be terminated by the target. In this case, the call is attempted again. Data about the success and failures of call may be stored and analyzed to improve callback strategies and algorithms. In other cases, the target may not be reached initially but the call may be placed on hold, connected to third party “gatekeepers”, directed to phone trees that must be navigated, and the like. The call server is equipped to deal with these occurrences such as navigating phone trees. If the target is not reached the call server may call back again according to the consumer profile and times established by the campaign.

When the target is reached, the call server creates a connection between the target and the consumer. In one embodiment, upon connection with target, the call server calls the phone of the consumer. Upon picking up the call, the consumer and target are connected, and the consumer can speak to the target to voice their opinion. In another embodiment, and transparently to the consumer, upon calling the target but before connecting to the target, the call server establishes a connection to the consumer's app. This connection remains persistent during the duration of time that the call server is attempting to reach the target. Then, upon connection to the target, the call server immediately bridges the connection between the consumer app and call server, and between the call server and target, such that the consumer and the target are in immediate communication. In this way, the target is totally unaware that the consumer did not call them, and the consumer is unaware and did not have to waste time trying to contact the target. It is completely automated. Alternatively, instead of using a phone app, this may equivalently be done in a web app, for example as an app embedded into a Facebook page or feed.

Once connected, the consumer may interact with and speak with the target however he wishes. Additionally, prepared scripts and talking points may be part of the campaign. Upon connection with the target, these talking points and scripts may be displayed on the consumer's app. And, the consumer may simply use that script or refer to the talking points when speaking with the target. In another embodiment, a prerecorded message may be communicated to the target. Also, the campaign may also provide collateral information such as text, audio, and video to motivate, educate, or guide the consumer in effectively participating in the campaign. Also, depending on the state or local law of the consumer's and target's locations, the consumer can record the phone call for example with a button that says, “Record Call”.

At the end of the call the call is disconnected, that is, the connections between the server and target, the server and consumer, and by extension between the consumer and the target, are terminated. The consumer, however, may be requested via the app to 1) fill-out a survey that describes how the call went (e.g. whether the target listened to them and recognized their concern); 2) type up or verbally record (for automatic transcription) a follow-up communication that will be sent to the target in fax, email or postal mail (with the option for consumer to pay for the fax or postage costs; 3) type up or verbally record (for automatic transcription) a memorialization directly in the app or via a link to a web form whereby the memorialization documents what they said and the target said in response, and gives the app and campaign manager software's and the campaigner's organizations permission to use this call memorialization for internal use or public dissemination (e.g. sharing with the press); or 4) where local/state law permits, allow the consumer to share the recording of the call with the app and app and campaign manager software's and the campaigner's organizations and permissions for distribution.

During the call and/or after the call, data about the call is stored at the call server. In one example, if permitted by law, the call may be recorded. The call may be automatically transcribed. The duration of the call, time stamps, call attempts, and so forth may be stored. The reports may further include the number of consumers, campaigners, targets, and volume and types of communications. This data is analyzed and reports are generated. The reports may be used by the campaigners to modify or understand the campaign better. The reports may be offered or even sold to organizations such as media organizations, governmental and non-governmental organizations, corporations, non-profits and other organization and individuals. Examples of media outlets include journalists, academics, redistricting commissions and others who may be interested in the communications to a target and the analytics and reports.

The calls may be repurposed. For example, in the case where the calls are transcribed, some or all of the calls may be converted into emails, faxes, and letters as part of the campaign.

The methods and systems may be implemented on any computer communicating over any network. For example, the computers may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The computer network(s) may include the interne and wireless networks such as a mobile phone network. Any reference to a “computer” is understood to include one or more computers operable to communicate with each other. Computers and devices comprise any type of computer capable of storing computer executable code and executing the computer executable code on a microprocessor, and communicating with the communication network(s). For example computer may be a web server.

References to electronic identifiers may be used which include, but are not limited to, email addresses, mobile phone numbers, user IDs for instant messaging services, user IDs for social networking application or mobile applications, user IDs and URLs for blogs and micro-blogs, URIs, bank account or financial institution numbers, routing numbers, credit and debit cards, any computer readable code, and other electronic identifiers to identify accounts, users, companies, and the like.

The systems and methods may be implemented on an Intel or Intel compatible based computer running a version of the Linux operating system or running a version of Microsoft Windows, Apple OS, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, wireless communication subsystem(s), and audio subsystems.

A non-transitory computer readable medium, such as the memory and/or the storage device(s) includes/stores computer executable code which when executed by the processor of the computer causes computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, an social networking instructions.

An application programming interface (API) permits the systems and methods to operate with other software platforms such as Salesforce CRM, Google Apps, Facebook, Twitter, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analog electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse or a trackball by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A method for electronic crowd communication for consumers to contact targets according to a campaign comprising the steps of:
(a) creating at least one campaign comprising at least one issue stored in a campaign database, wherein the campaign is created by a campaign manager application;
(b) creating a target database wherein the target database comprises a plurality of targets wherein each target is linked to at least one of the campaign of (a), wherein the target database comprises contact information of each target;
(c) creating a consumer profile comprising name, date of birth, voting district information, contact information, and time calling preferences the consumer is available for calls;
(d) creating a campaign database with an online campaign manager application;
(e) providing a consumer app executing on a mobile device of a user;
(f) transmitting a campaign from the campaign manager to the consumer app of users having a consumer profile that matches the requirements of the campaign;
(g) receiving input from users by way of their consumer app indicating the user would like to support the campaign; and
(h) according to the time calling preferences, automatedly calling the target and connecting the consumer to the target so that the consumer can speak with the target, wherein automatedly calling further comprises queuing calls and load balancing calls to the targets according to the number of consumers available to call the target based on the consumer's time calling preferences.
